(19) United States
(12) Patent Application Publication
(10) Pub. No.: US 2015/0026638 A1
(43) Pub. Date: Jan. 22, 2015

(54) APPARATUS AND METHOD OF CONTROLLING EXTERNAL INPUT DEVICE, AND COMPUTER-READABLE RECORDING MEDIUM

(71) Applicant: Samsung Electronics Co., Ltd., Gyeonggi-do (KR)

(72) Inventors: Seung-Nyun KIM, Incheon (KR); Geon-Soo Kim, Gyeonggi-do (KR); Yong-Joon Jeon, Gyeonggi-do (KR)

(73) Assignee: Samsung Electronics Co., Ltd., Gyeonggi-do (KR)

(21) Appl. No.: 14/257,375

(22) Filed: Apr. 21, 2014

(30) Foreign Application Priority Data
Jul. 18, 2013 (KR) 10-2013-0084683

(51) Int. Cl. G06F 3/0482; G06F 3/01

(52) U.S. Cl. CPC G06F 3/0482; G06F 3/016
USPC 715/810

(57) ABSTRACT

An electronic device and a method of controlling an external input device, and a computer-readable recording medium having recorded thereon a program to perform the method are provided. The electronic device includes a communication unit configured to receive a signal generated from the external input device, and a controller configured to control display of a pointer according to the signal and to control display of a menu corresponding to a key button of the electronic device, upon receiving one of a specific signal from the external input device and if the pointer is positioned in a specific area.

### PRIORITY

This application claims priority under 35 U.S.C. §119(a) to a Korean patent application filed in the Korean Intellectual Property Office on Jul. 18, 2013 and assigned Serial No. 10-2013-0084683, the entire content of which is incorporated herein by reference.

### BACKGROUND OF THE INVENTION

1. Field of the Invention

The present invention relates generally to an electronic device, and more particularly, to an electronic device and method of controlling an external input device, and a computer-readable recording medium.

2. Description of the Related Art

A user may control an electronic device using an external input device that provides a user input. The input device includes a mouse, a joystick, an electronic pen mouse, an electronic pen, a tablet digitizer, a keyboard, a keypad, a track ball, and the like.

An electronic device is equipped with at least one display. If an input device is connected wirelessly or by wire to the electronic device, a user may control the electronic device through a User Interface (UI) configured between the input device and the electronic device. The user may apply inputs to the UI in various manners including a keypad input, a touch input, or a hovering input on or above a touch screen of a display of the electronic device.

Along with the rapid development of technologies, various techniques of inputting to a UI between an input device and an electronic device have been developed, including a user gesture, voice, eye movement, and a vital signal.

If the user wants to manipulate hard keys in the electronic device, he or she touches or presses the hard keys directly to execute functions corresponding to the hard keys. To control the hard keys of the electronic device, the user directly manipulates the hard keys even though the electronic device is connected to an input device. Accordingly, a need exists for enabling the user to readily control the hard keys in the electronic device through a screen of the display in the electronic device using the input device connected to the electronic device.

### SUMMARY OF THE INVENTION

The present invention has been made to address at least the problems and disadvantages described above, and to provide at least the advantages described below. Accordingly, an aspect of the present invention is to provide an electronic device and a method of controlling hard keys in an electronic device through a screen of a display in the electronic device using an input device configured, and a computer-readable recording medium to perform the method.

In accordance with an aspect of the present invention, an electronic device connected to an external input device is provided. The electronic device includes a communication unit configured to receive a signal generated from the external input device, and a controller configured to control display of a pointer according to the signal and to control display of a menu corresponding to a key button of the electronic device, upon one of receiving a specific signal from the external input device and if the pointer is positioned in a specific area.

In accordance with another aspect of the present invention, a method of controlling an electronic device connected to an external input device that provides a user input is provided. The method includes displaying a pointer controlled according to a signal generated from the external input device, and displaying a menu corresponding to a key button of the electronic device, upon one of receiving a specific signal from the external input device and if the pointer is positioned in a specific area.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 illustrates a block diagram of a portable terminal as an electronic device configured to control an external input device according to an embodiment of the present invention;

FIG. 2 illustrates a front perspective view of a portable terminal according to an embodiment of the present invention;

FIG. 3 illustrates a rear perspective view of a portable terminal according to an embodiment of the present invention;

FIG. 4 illustrates a block diagram of a controller in an electronic device configured to control an external input device according to an embodiment of the present invention;

FIG. 5 is a flowchart illustrating a method of controlling an external input device according to an embodiment of the present invention;

FIG. 6 is a flowchart illustrating a method of controlling an external input device according to an embodiment of the present invention;

FIGS. 7A and 7B illustrate an application example of a method of controlling an external input device according to an embodiment of the present invention;

FIGS. 8A and 8B illustrate an application example of a method of controlling an external input device according to an embodiment of the present invention; and

FIGS. 9A and 9B illustrate an application example of a method of controlling an external input device according to an embodiment of the present invention.

Throughout the drawings, like reference numerals will be understood to refer to like parts, components, and structures.

### DETAILED DESCRIPTION OF EMBODIMENTS OF THE PRESENT

INVENTION

The following description with reference to the accompanying drawings is provided to assist in a comprehensive understanding of embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of constructions or processes known in the art may be omitted for clarity and conciseness.

The terms and words used in the following description and claims are not limited to their dictionary meanings, but, are merely used to enable a clear and consistent understanding of the invention. Accordingly, it should be apparent to those skilled in the art that the following description of embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Embodiments of the present invention will be provided to achieve the technical aspects of the present invention described above. In various implementations, defined entities may have the same names, to which the present invention is not limited. Thus, embodiments of the present invention can be implemented with same or ready modifications in a system having a similar technical background.

Embodiments of the present invention provide an electronic device equipped with at least one display (e.g. a digital camera, a smart phone, a tablet computer, and the like), which is connected to an input device and controls hard keys through the input device, and provide a method of controlling the electronic device.

In embodiments of the present invention, an electronic device is a device equipped with at least one display and may be any of a portable terminal such as a smart phone, a portable phone, a game console, a Television (TV), a display device, an in-vehicle video head unit, a laptop computer, a tablet computer, a Personal Media Player (PMP), a Personal Digital Assistant (PDA), a navigator, and the like. Moreover, the electronic device may be a flexible device or a flexible display device.

In the following description of embodiments of the present invention, as opposed to soft keys that are programmable to execute different functions according to user selections, hard keys are physical keys or buttons. The hard keys may be formed on a top side surface, a bottom side surface, a left side surface, and/or a right side surface of a housing in the electronic device. The hard keys may be formed in any part of the housing except for a display of the electronic device. The term ‘hard key’ may be replaced with ‘hardware button’ or ‘hardware key’.

In an embodiment of the present invention, at least one hard key mapping area is defined on a screen of a display in an electronic device and is mapped to at least one hard key in the electronic device. If a pointer moves into a hard key mapping area on the screen of the display in the electronic device in response to an input signal from an input device, a function corresponding to at least one hard key mapped to the hard key mapping area may be executed.

An input device that provides a user input according to an embodiment of the present invention may include at least one of the following: a keyboard, a keypad, a track ball, and a pointing device such as a mouse, a joystick, an electronic pen mouse, an electronic pen, and a tablet digitizer.

If the input device is included in a housing of the electronic device, the input device may be connected by wire to the electronic device. If a mounting space is defined in the housing of the electronic device so that the input device may be inserted into or removed from the mounting space, the input device may be connected wirelessly or by wire to the electronic device. For example, when an electronic pen is removed from a mounting space defined in the electronic device, the electronic pen may be connected to the electronic device wirelessly.

If the input device is physically independent of the electronic device, the input device may be connected wirelessly or by wire to the electronic device directly or via an additional intermediate electronic device. For example, a mouse as an input device may be connected wirelessly or by wire to a computer, and the computer as an intermediate electronic device may be connected wirelessly or by wire to the electronic device. Thus, the mouse as an input device may be connected to the electronic device wirelessly or by wire via the computer serving as an intermediate electronic device. A pointer may be moved into a hard key mapping area mapped to at least one hard key on the display of the electronic device by the mouse. Thus a function corresponding to the at least one hard key is executed.

When the input device is connected to the electronic device via an intermediate electronic device, the input device may select one between the electronic device and the intermediate electronic device and transmit an input signal to the selected electronic device. For example, a mouse as an input device may be connected to a computer, and the computer as an intermediate electronic device may be connected to the electronic device. Therefore, the mouse may select the computer or the electronic device and may transmit a user input signal to the selected computer or electronic device.

When the input device is included in the electronic device and connected to another electronic device, the input device may select one between the electronic device and the other electronic device and transmit a user input signal to the selected electronic device. For example, a mouse as an input device may be connected to the electronic device, and the electronic device may be connected to another electronic device. Thus, the mouse may select one of the electronic devices and transmit a user input signal to the selected electronic device. In other words, the input device included in an electronic device may serve as an input device for another electronic device.

Once the electronic device is connected to an input device, the electronic device may generate a pointer at a position on the display. The electronic device may receive an input signal from the input device to trigger movement of the pointer and move the pointer from one position to another on the display corresponding to the input signal. If the pointer moves into a hard key mapping area mapped to at least one hard key on the display of the electronic device, the electronic device may receive a selection signal to trigger execution of a function from the input device and execute a function corresponding to the at least one hard key mapped to the hard key mapping area.

In an embodiment of the present invention, the electronic device may map at least one hard key of the electronic device to at least one hard key mapping area defined on the display as follows.

For example, the electronic device may define a hard key mapping area per hard key on the display and thus map the defined hard key mapping areas to the hard keys in a one-to-one correspondence. For example, a hard key mapping area may be defined at an edge of the display, nearest to the mapped hard key. Thus, hard mapping areas may be defined for as many as the number of hard keys on the display of the electronic device.

In another example, the electronic device may define one hard key mapping area to a plurality of hard keys that control the same object corresponding to similar functions. For example, a hard key mapping area may be defined at an edge of the display, near to the mapped volume buttons that control the sound volume of the electronic device (a volume-up button and a volume-down button). Thus, the user may control an intended function among similar functions corresponding to a plurality of hard keys that control the same object through an input device connected to the electronic device.

In another example, the electronic device may map one hard key mapping area defined on the display to a plurality of hard keys corresponding to different functions. The hard keys corresponding to different functions may be, for example, a volume-up button, a volume-down button, a menu button, a home button, a back button, and a power/lock button. Thus, the user may control an intended function among the different functions corresponding to the plurality of hard keys through an input device connected to the electronic device.

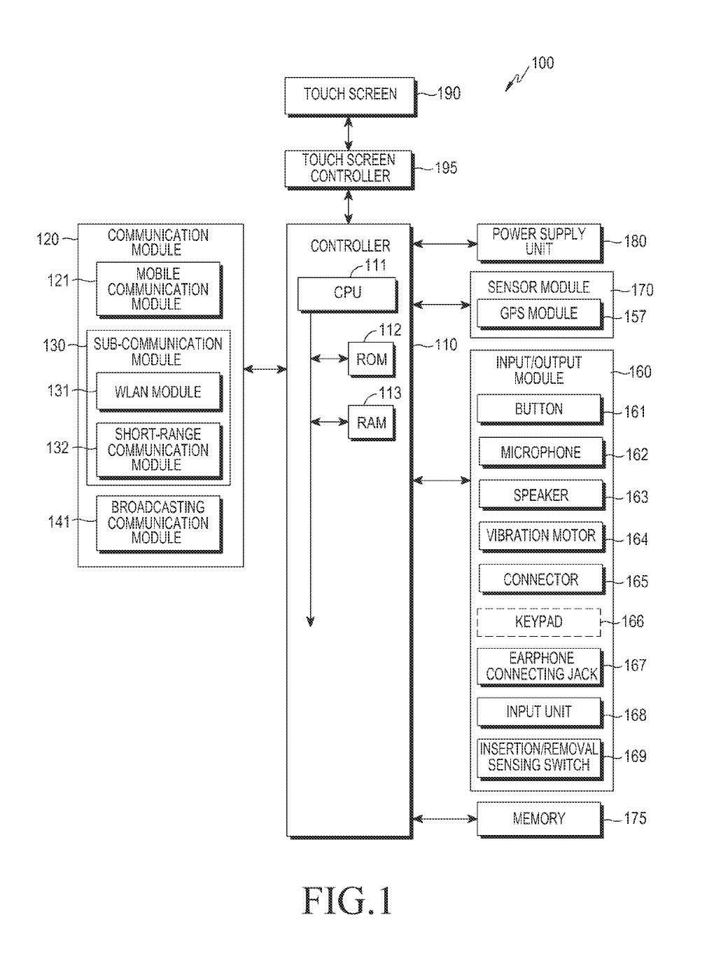

FIG. 1 illustrates a block diagram of a portable terminal as an electronic device that controls hardware buttons on a screen using an input device according to an embodiment of the present invention.

Referring to FIG. 1, a portable terminal 100 may be connected to an external electronic device through at least one of the following: a communication module 120, a connector 165, and an earphone connector jack 167. The external electronic device may be any of a variety of devices that is detachably connected to the portable terminal 100 by wire, such as an earphone, an external speaker, a Universal Serial Bus (USB) memory, a charger, a cradle, a docking station, a Digital Multimedia Broadcasting (DMB) antenna, a mobile payment device, a health care device (e.g. a blood sugar meter, etc.), a game console, a vehicle navigator, and a device having an input means. The external electronic device may also be a Bluetooth communication device, a Near Field Communication (NFC) device, a Wireless Fidelity (Wi-Fi) Direct communication device, or a wireless Access Point (AP), which is wirelessly connectable to the portable terminal 100. The portable terminal 100 may be connected wirelessly or by wire to another portable terminal or another electronic device, such as a portable phone, a smart phone, a tablet Personal Computer (PC), a desktop PC, and a server.

The portable terminal 100 may be connected to an input device through at least one of the following: the communication module 120, the connector 165, and the earphone connector jack 167.

The portable terminal 100 may include at least one touch screen 190 and at least one touch screen controller 195. The portable terminal 100 may further include a controller 110, the communication module 120, an Input/Output (I/O) module 160, a sensor module 170, a memory (storage) 175, and a power supply 180. The communication module 120 may include a mobile communication module 121, a sub-communication module 130, and a broadcasting communication module 141. The sub-communication module 130 may include at least one of a Wireless Local Area Network (WLAN) module 131 and a short-range communication module 132. The I/O module 160 may include at least one of the following: buttons 161, a microphone 162, a speaker 163, a vibration device 164, the connector 165, and a keypad 166.

The controller 110 may include a Central Processing Unit (CPU) 111, a Read Only Memory (ROM) 112 that stores a control program to control the portable terminal 100, and a Random Access Memory (RAM) 113 that stores signals or data received from the outside of the portable terminal 100 or used as a memory space for an operation performed by the portable terminal 100. The CPU 111 may include one or more cores. The CPU 111, the ROM 112, and the RAM 113 may be connected to one another through an internal bus.

The controller 110 may control the communication module 120, the I/O module 160, the sensor module 170, the memory 175, the power supply 180, the touch screen 190, and the touch screen controller 195.

The controller 110 may map at least one hard key mapping area defined on the touch screen 190 to the buttons 161. The controller 110 may define at least one hard key mapping area to which the mapped buttons are mapped, on the touch screen 190. The controller 110 may map the at least one hard key mapping area to the buttons 161 and store area-button mapping information in the memory 175.

When an input device is connected to the portable terminal 100, the controller 110 may generate a pointer at a position on the touch screen 190. Upon receiving an input signal from the input device, the controller 110 may move the pointer from one position to another corresponding to the input signal on a screen of the display.

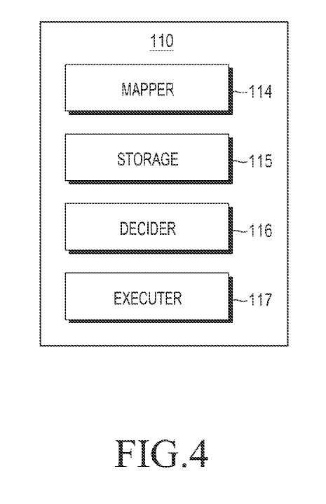

The controller 110 may determine whether or not the pointer 161 has been moved into a hard key mapping area mapped to at least one button 161 on the touch screen 190. If the pointer 161 is positioned in a hard key mapping area mapped to at least one button 161, the controller 110 may receive a selection signal from the input device and execute a function corresponding to the at least one button 161 according to the selection signal. The configuration of the controller 110 according to an embodiment of the present invention will be described later in detail with reference to FIG. 4.

In an embodiment of the present invention, a user input applied to the portable terminal 100 may include a user input on the touch screen 190, a gesture input through a camera module, a switch/button input through the buttons 161 or the keypad 166, a voice input through the microphone 162, and the like.

The controller 110 may sense a user input event such as a hovering event that is generated when an input unit 168 approaches the touch screen 190 from above or nearby above the touch screen 190.

The controller 110 may detect various user inputs received through the camera module, the I/O module 160, the sensor module 170, and the touch screen 190. The user inputs may include various types of information input to the portable terminal 100, such as a touch, a user gesture, a voice, eye movement, iris recognition, a vital signal, and the like. The controller 110 may control execution of a predetermined operation or function corresponding to a detected user input in the portable terminal 100.

The controller 110 may output a control signal to the input unit 168 (e.g. a stylus pen, an electronic pen, and the like) or the vibration device 164. The control signal may include information about a vibration pattern and thus the input unit 168 or the vibration device 164 generates vibrations according to the vibration pattern. The information about the vibration pattern may specify the vibration pattern itself, an IDentifier (ID) of the vibration pattern, or the like. Alternatively, this control signal may include only a vibration generation request.

The portable terminal 100 may include at least one of the mobile communication module 121, the WLAN module 131, and the short-range communication module 132 based on the capabilities of the portable terminal 100.

The mobile communication module 121 may connect the portable terminal 100 to an external electronic device through one or more antennas by mobile communication under the control of the controller 110. The mobile communication module 121 may transmit wireless signals to or may receive wireless signals from a portable phone, a smart phone, a tablet PC, or another electronic device, for a voice call, a video call, a Short Message Service (SMS), or a Multimedia Messaging Service (MMS).

The sub-communication module 130 may include at least one of the WLAN module 131 and the short-range communication module 132. For example, the sub-communication module 130 may include only the WLAN module 131, only the short-range communication module 132, or both the WLAN module 131 and the short-range communication module 132.

The WLAN module 131 may be connected to the Internet under the control of the controller 110 in a place where a wireless AP (not shown) is installed. The WLAN module 131 supports the WLAN standard, Institute of Electrical and Electronics Engineers (IEEE) 802.11x. The short-range communication module 132 may conduct short-range wireless communication between the portable terminal 100 and an external electronic device under the control of the controller 110. The short-range communication may conform to Bluetooth, Infrared Data Association (IrDA), Wi-Fi Direct, NFC, visible light communication, and the like.

The portable terminal 100 may be connected to an input device via the sub-communication module 130.

The broadcasting communication module 141 may receive a broadcast signal (e.g., a TV broadcast signal, a radio broadcast signal, or a data broadcast signal) and additional broadcasting information (e.g., an Electronic Program Guide (EPG) or Electronic Service Guide (ESG)) from a broadcasting station through a broadcasting communication antenna under the control of the controller 110.

The I/O module 160 may include at least one of at least one button 161, at least one microphone 162, at least one speaker 163, at least one vibration device 164, the connector 165, the keypad 166, the earphone connector jack 167, and the input unit 168. The I/O module 160 is not limited thereto, and a cursor control such as a mouse, a track ball, a joystick, or cursor directional keys may be provided to control movement of a cursor on the touch screen 190.

The buttons 161 may be formed on the front surface, a side surface, or the rear surface of a housing (or case) of the portable terminal 100, and may include at least one of a power/lock button, a volume button, a menu button, a home button, a back button, and a search button.

The microphone 162 may receive a voice or a sound and convert the received voice or sound to an electrical signal under the control of the controller 110.

The speaker 163 may output sounds corresponding to various signals or data (e.g., wireless data, broadcast data, digital audio data, digital video data, and the like) to the outside of the portable terminal 100 under the control of the controller 110. The speaker 163 may output sounds corresponding to functions (e.g., a button manipulation sound, a ringback tone, a voice from the other party, and the like in a call) performed by the portable terminal 100. One or more speakers 163 may be disposed at an appropriate position or appropriate positions of the housing of the portable terminal 100.

Upon executing a function corresponding to a hardware button 161 under the control of the controller 110, the speaker 163 may output a sound corresponding to the executed function in the portable terminal 100.

The vibration device 164 may convert an electrical signal to a mechanical vibration under the control of the controller 110. For example, when the portable terminal 100 receives an incoming voice call or video call from another device in a vibration mode, the vibration device 164 operates. One or more vibration devices 164 may be mounted inside the housing of the portable terminal 100. The vibration device 164 may operate in response to a user input on the touch screen 190.

Upon executing a function corresponding to a hardware button 161 under the control of the controller 110, the vibration device 164 may output a mechanical vibration corresponding to the executed function in the portable terminal 100. The vibration device 164 may vibrate with different vibration strengths during different vibration periods corresponding to different functions of the buttons 161.

The connector 165 may be used as an interface to connect the portable terminal 100 to an external electronic device. The controller 110 may transmit data stored in the memory 175 to the external electronic device or receive data from the external electronic device via a cable connected to the connector 165. The portable terminal 100 may receive power or charge a battery from the power source via the cable connected to the connector 165.

The connector 165 may also be used as an interface to connect the portable terminal 100 to a device having an input means. The connector 165 may also be used as an interface to connect the portable terminal 100 to an intermediate electronic device that has been connected to a device having an input means.

The keypad 166 may receive a key input from the user to control the portable terminal 100. The keypad 166 may include a physical keypad formed in the portable terminal 100 or a virtual keypad displayed on the touch screen 190.

The keypad 166 as an input device may be detachably included in the portable terminal 100 or disposed inside the housing of the portable terminal 100. The physical keypad 166 may not be provided based on the capabilities or configuration of the portable terminal 100.

An earphone may be inserted into the earphone connector jack 167 and thus connected to the portable terminal 100.

The input unit 168 may be inserted and kept in the portable terminal 100. When the input unit 168 is used, it may be extended or removed from the portable terminal 100. An insertion/removal sensing switch 169 is provided in an internal area of the portable terminal 100 where the input unit 168 is inserted, in order to properly respond to insertion and removal of the input unit 168. The insertion/removal sensing switch 169 may output signals corresponding to insertion and removal of the input unit 168 to the controller 110. The insertion/removal sensing switch 169 may directly or indirectly contact the input unit 168, when the input unit 168 is inserted. Therefore, the insertion/removal sensing switch 169 may output, to the controller 110, a signal corresponding to insertion or removal of the input unit 168 (i.e. a signal indicating insertion or removal of the input unit 168) depending on whether the insertion or removal of the input unit 168 contacts the input unit 168.

The input unit 168 may be a device having an input means. When the input unit 168 is extended or removed from the portable terminal 100, the controller 110 may generate a pointer at a position on the touch screen 190. If the input unit 168 is placed on or above the touch screen 190, the controller 110 may detect a change in the position of the input unit 168 and then may move the pointer in correspondence with the position change.

The sensor module 170 includes at least one sensor to detect a state of the portable terminal 100. For example, the sensor module 170 may include a proximity sensor that detects whether or not the user is close to the portable terminal 100, an illuminance sensor that detects the amount of ambient light around the portable terminal 100, a motion sensor that detects a motion of the portable terminal 100 (e.g., rotation, acceleration or vibration of the portable terminal 100), a geo-magnetic sensor that detects a point of the compass of the portable terminal 100 using the earth's magnetic field, a gravity sensor that detects the direction of gravity, an altimeter that detects an altitude by measuring the air pressure, and a Global Positioning System (GPS) module 157.

The GPS module 157 may receive signal waves from a plurality of GPS satellites in Earth orbit and calculate a position of the portable terminal 100 based on the Time of Arrivals (ToAs) of satellite signals from the GPS satellites to the portable terminal 100.

The memory 175 may store input/output signals or data in accordance with operations of the communication module 120, the I/O module 160, the sensor module 170, and the touch screen 190 under the control of the controller 110. The memory 175 may store a control program to control the portable terminal 100 or the controller 110, and other applications.

The term “memory” covers the memory 175, the ROM 112 and the RAM 113 within the controller 110, or a memory card (not shown) (e.g. a Secure Digital (SD) card or a memory stick) mounted to the portable terminal 100. The memory may include a non-volatile memory, a volatile memory, a Hard Disk Drive (HDD), or a Solid State Drive (SSD).

The memory 175 may store applications having various functions such as navigation, video call, game, and time-based alarm applications, images used to provide Graphical User Interfaces (GUIs) related to the applications, user information, texts, databases or data related to a method of processing a touch input, background images (e.g. a menu screen, a waiting screen, and the like) or operation programs required to operate the terminal 100, and images captured by the camera module.

The memory 175 stores information about mapping between the buttons 161 and at least one hard key mapping area defined on the touch screen 190 under the control of the controller 110. For example, the mapping information may include information about the size of the at least one hard key mapping area on a screen of the display and information about a function corresponding to at least one button 161 mapped to the at least one hard key mapping area.

The memory 175 is a machine-readable medium (e.g. a computer-readable medium). A machine-readable medium may be defined as a medium that provides data to a machine so that the machine may perform a specific function. The memory 175 may include a volatile medium and a non-volatile medium. All these media should be a type that transfers commands detectable by a physical device that reads the commands to the machine

The machine-readable medium includes, but not limited to, at least one of the following: a floppy disk, a flexible disk, a hard disk, a magnetic tape, a Compact Disk Read Only Memory (CD-ROM), an optical disk, a punch card, a paper tape, a RAM, a Programmable ROM (PROM), an Erasable PROM (EPROM), a Flash-EPROM, and an embedded Multi Media Card (eMMC).

The power supply 180 may supply power to one or more batteries mounted in the housing of the portable terminal 100 under the control of the controller 110. The one or more batteries supply power to the portable terminal 100. Moreover, the power supply 180 may supply power received from an external power source via the cable connected to the connector 165 to the portable terminal 100. The power supply 180 may also supply power received wirelessly from the external power source to the portable terminal 100 by a wireless charging technology.

The portable terminal 100 may include the at least one touch screen 190 that provides GUIs corresponding to various services (e.g. call, data transmission, broadcasting, photo shot, etc.). The touch screen 190 may output an analog signal corresponding to at least one user input to a GUI to the touch screen controller 195.

The touch screen 190 may receive at least one user input through a user's body (e.g. a finger) or the input unit 168 (e.g., a stylus pen, an electronic pen, etc.). The touch screen 190 may be implemented as, for example, a resistive type, a capacitive type, an infrared type, an acoustic wave type, or in a combination thereof.

The touch screen 190 may include at least two touch panels in order to receive inputs of the finger and the input unit 168. One panel senses a finger's touch or proximity and the other senses a touch or proximity of the input unit 168. The at least two touch panels may provide different output values to the touch screen controller 195, and the touch screen controller 195 may distinguish a finger's input to the touch screen 190 from an input of the input unit 168 to the touch screen 190 by identifying the different values received from the at least two touch screen panels.

The touch may include a non-contact touch (e.g. a detectable gap exists between the touch screen 190 and the user's body part or a touch input, typically 1 mm or less), and may not be limited to contact touch between the touch screen 190 and the user's body part or the touch input means. The gap detectable by the touch screen 190 may vary based on the capabilities or configuration of the portable terminal 100.

The touch screen controller 195 converts an analog signal received from the touch screen 190 to a digital signal. The controller 110 may control the touch screen 190 using the digital signal received from the touch screen controller 195. The touch screen controller 195 may control a hovering gap or distance as well as a user input position by detecting a value output from the touch screen 190 (e.g. a current value or the like), convert the hovering gap or distance to a digital signal, and provide the digital signal to the controller 110. Further, the touch screen controller 195 may detect a value output from the touch screen 190 (e.g. a current value or the like), detect pressure applied to the touch screen 190 by the user input means, convert the detected pressure value to a digital signal, and provide the digital signal to the controller 110.

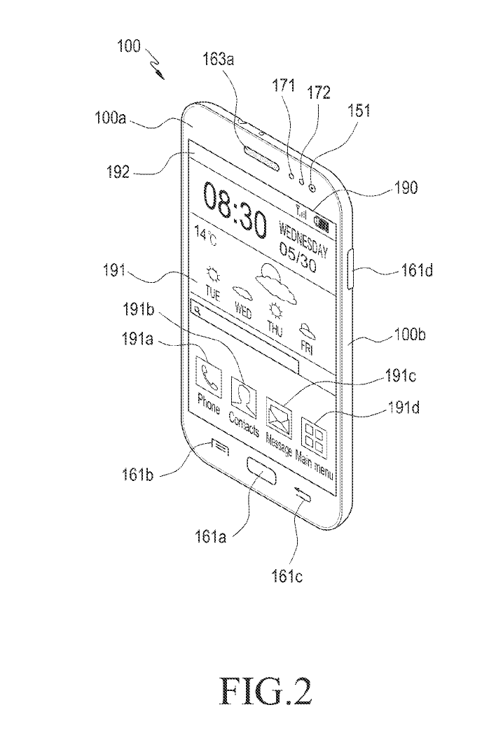

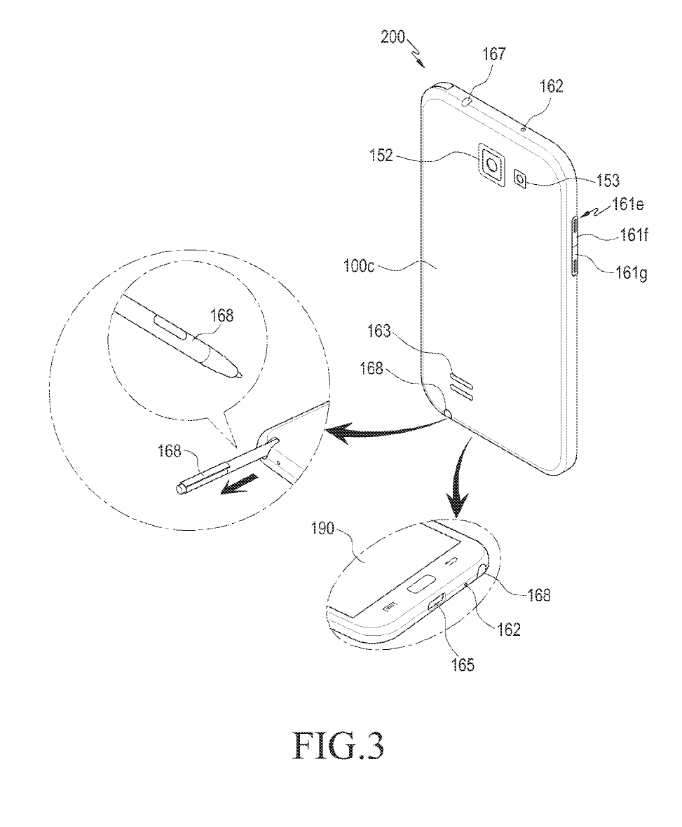

FIGS. 2 and 3 illustrate front and rear perspective views, respectively, of a portable terminal according to an embodiment of the present invention.

Referring to FIGS. 2 and 3, the touch screen 190 is disposed at the center of the front surface 101 of the portable terminal 100, occupying almost the entirety of the front surface 101. In FIG. 2, a main home screen is displayed on the touch screen 190 by way of example. The main home screen is the first screen to be displayed on the touch screen 190, when the portable terminal 100 is powered on. When the portable terminal 100 has different home screens of a plurality of pages, the main home screen may be the first of the home screens of the plurality of pages. Shortcut icons 191a, 191b and 191c used to execute frequently used applications, a main menu switch key 191d, the time, weather, and the like may be displayed on the home screen. Once the user selects the main menu switch key 191d, a menu screen is displayed on the touch screen 190. A status bar 192 may be displayed at the top of the touch screen 190 in order to indicate states of the portable terminal 100 such as a battery charged state, a received signal strength, and a current time.

A home button 161a, a menu button 161b, and a back button 161c may be formed at the bottom of the touch screen 190. The home button 161 a is used to display the main home screen on the touch screen 190. For example, once the user selects the home button 161 a while any home screen other than the main home screen or the menu screen is displayed on the touch screen 190, the main home screen may be displayed on the touch screen 190. Once the user selects the home button 161 a during execution of applications on the home screen 190, the main home screen may be displayed on the touch screen 190. The home button 161a may also be used to display recently used applications or a task manager on the touch screen 190.

The menu button 161b provides link menus that can be displayed on the touch screen 190. The link menus may include a widget adding menu, a background changing menu, a search menu, an edit menu, an environment setting menu, and the like.

The back button 161 c is used to display the screen previous to a current screen or end the latest used application.

A first camera 151, an illuminance sensor 170a, and a proximity sensor 170b may be arranged at a corner of the front surface 101 of the portable terminal 100, while a second camera 152, a flash 153, and the speaker 163 may be arranged on the rear surface 103 of the portable terminal 100.

For example, the power/lock button 161d, a volume button 161e including a volume up button 161f and a volume down button 161g, a terrestrial Digital Multimedia Broadcasting (DMB) antenna that receives a broadcast signal, and one or more microphones 162 may be disposed on side surfaces 102 of the portable terminal 100. The DMB antenna may be mounted to the portable terminal 100 fixedly or detachably.

The connector 165 is formed on the bottom side surface of the portable terminal 100. The connector 165 may include a plurality of electrodes and may be connected to an external device by wire. The earphone connector jack 167 may be formed on the top side surface of the portable terminal 100, in order to allow an earphone to be inserted.

The input unit 168 may be installed to the bottom side surface of the portable terminal 100. The input unit 168 may be inserted and kept in the portable terminal 100. When the input unit 168 is used, the input unit may be extended and removed from the portable terminal 100.

The afore-described buttons 161 may include hard keys.

With reference to FIGS. 4 to 9B, an electronic device and a method of controlling an external input device according to an embodiment of the present invention will be described.

FIG. 4 is a block diagram illustrating a detailed configuration of a controller in an electronic device that controls an external input device according to an embodiment of the present invention.

Referring to FIG. 4, the controller 110 may include a mapper 114 that maps at least one hard key of the electronic device to at least one hard key mapping area defined on the display, a storage 115 that stores information about mapping between the at least one hard key and the at least one hard key mapping area, a decider 116 that determines whether a pointer is located in a hard key mapping area mapped to at least one hard key, and an executer 117 that, when the pointer is located in a hard key mapping area mapped to at least one hard key, receives a selection signal related to execution of a function corresponding to the at least one hard key from an input device and executes the function corresponding to the at least one hard key mapped to the hard key mapping area.

Hard keys of the electronic device may be installed in the housing except for the display. In general, a plurality of hard keys that control the same object may be installed near each other. For example, a volume-up button and a volume-down button that control sound volume may be installed near each other.

The mapper 114 may define at least one hard key mapping area on a screen of the display, to which at least one hard key is mapped. The at least one hard key mapping area may be defined at an edge of the display, near the mapped at least one hard key. For example, the electronic device may define a hard key mapping area having a predetermined size at an edge of the display, near to the position of a mapped hard key. The mapper 114 maps the at least one hard key to the defined at least one hard key mapping area.

The mapper 114 may define at least one hard key mapping area having a predetermined size on the display and map hard keys to the at least one hard key mapping area. The mapper 114 may define a hard key mapping area for each hard key and map the hard key mapping areas to the hard keys in a one-to-one correspondence.

The mapper 114 may define one hard key mapping area on a screen of the display and map a plurality of hard keys that control the same object to the hard key mapping area. For example, a volume-up button and a volume-down button may be mapped to one hard key mapping area.

The mapper 114 may define one hard key mapping area on a screen of the display and map a plurality of hardware buttons that perform different functions to the hard key mapping area. For example, if the display of the electronic device is small, formation of a plurality of hard key mapping areas mapped to hard keys may cause user's inconvenience in using the electronic device. On the other hand, if a plurality of hard keys that perform different functions are mapped to a single hard key mapping area, the electronic device may receive a selection signal from the input device so that the user may execute an intended function from among functions corresponding to the plurality of hard keys.

The mapper 114 may define at least one hard key mapping area in a predetermined size on the display. The size of each hard key mapping area may be preset by the user or the manufacturer of the electronic device. Alternatively, when the input device is initially connected to the electronic device, the user may set the size of each hard key mapping area.

The storage 115 may store information about mapping between at least one hard key mapping area and at least one hard key in the mapper 114. For example, the storage 115 may store information about the size of the at least one hard key mapping area and information about a function corresponding to the at least one hard key mapped to the at least one hard key mapping area.

The decider 116 may determine whether a pointer is positioned in a hard key mapping area mapped to at least one hard key. When the input device is connected to the electronic device, the electronic device may generate a pointer at a position on the display. Upon receiving an input signal from the input device, the electronic device may move the pointer on the screen of the display in correspondence with the input signal. The decider 116 may determine whether the pointer is positioned in a hard key mapping area during movement according to the input signal.

If the pointer stays in a hard key mapping area longer than a predetermined time, the decider 116 may determine that the pointer is positioned in the hard key mapping area. The predetermined time may be set by the user or the manufacturer of the electronic device.

If the decider 116 determines that the pointer is positioned in the hard key mapping area mapped to at least one hard key, the executer 117 may receive a selection signal from the input device and execute a function corresponding to the at least one hard key according to the selection signal.

If the pointer is positioned in the hard key mapping area mapped to the at least one hard key, the executer 117 may display a function corresponding to the at least one hard key on a screen of the display. The function may be displayed as a text, a figure, and an icon.

If a plurality of hard keys are mapped to a hard key mapping area in which the pointer is positioned, the executer 117 may display a list of functions corresponding to the hard keys.

If a plurality of hard keys are mapped to a hard key mapping area in which the pointer is positioned, the executer 117 may display functions corresponding to the hard keys sequentially one by one in a predetermined order. Each function may be in the form of a text, a figure, and an icon displayed on a screen of the display, each time an input signal is received from the input device.

If the pointer enters a hard key mapping area, the executer 117 may receive a hard key function display signal associated with display of one or more functions corresponding to at least one hard key mapped to the hard key mapping area from the input device. Then the executer 117 may display the one or more functions corresponding to the at least one hard key mapped to the hard key mapping area on the screen of the display according to the hard key function display signal.

For example, if the input device is a mouse and the pointer moves out of a hard key mapping area and then returns to the hard key mapping area within a predetermined time according to an input signal from the mouse, the electronic device may recognize the movement and returning of the pointer within the predetermined time as a hard key function display signal and may display one or more functions corresponding to at least one hard key mapped to the hard key mapping area on a screen of the display.

In another example, if the input device is a mouse, the electronic device may receive a right-button signal as a hard key function display signal from the mouse and display one or more functions corresponding to at least one hard key mapped to a hard key mapping area in which the pointer is positioned, on a screen of the display.

In another example, if the input device is a mouse, when the user clicks or touches a hard key mapping area and then moves the pointer, the electronic device may recognize the click or touch and movement of the pointer as a hard key function display signal and may display one or functions corresponding to at least one hard key mapped to the hard key mapping area on a screen of the display.

In another example, if the input device is a mouse, when the user holds the pointer in a hard key mapping area longer than a predetermined time, the electronic device may recognize the holding of the pointer as a hard key function display signal and may display one or more functions corresponding to at least one hard key mapped to the hard key mapping area on a screen of the display.

The executer 117 may receive a selection signal related to execution of a function corresponding to a hard key from the input device and indicate execution of a function corresponding to at least one hard key mapped to a hard key mapping area in which the pointer is positioned according to the received selection signal by illuminating at least one light emitting device. For example, the at least one light emitting device may be illuminated in different colors for different functions corresponding to the hard keys.

The executer 117 may receive a selection signal related to execution of a function corresponding to a hard key from the input device and indicate execution of a function corresponding to at least one hard key mapped to a hard key mapping area in which the pointer is positioned according to the received selection signal by vibrating at least one vibration device. For example, the at least one vibration device may vibrate with different vibration strengths or for different vibration periods for different functions corresponding to the hard keys.

The components of the controller 110 are illustrated in FIG. 4 as separate configurations to indicate that the functions of the components may be logically separated. This does not necessarily mean that the components of the controller 110 should be separated physically or configured in separate codes.

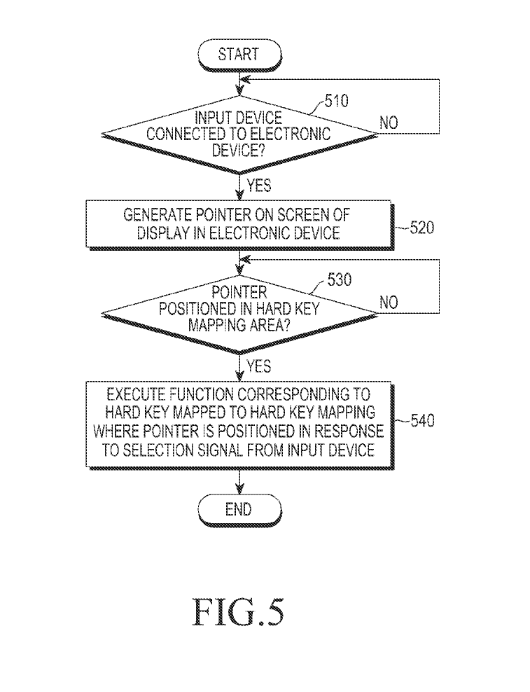

FIG. 5 is a flowchart illustrating a method for controlling an external input device according to an embodiment of the present invention.

Referring to FIG. 5, an electronic device may determine whether or not an input device has been connected to the electronic device in step 510. If the input device has been connected to the electronic device, the procedure may go to step 520. On the other hand, if the input device has not been connected to the electronic device, the electronic device may wait until it is connected to the input device. The input device may be any of the following: an input device included in a housing of the electronic device, an input device detachably installed in the electronic device, and an input device physically independent of the electronic device. If the input device is included in the housing of the electronic device, once the input device is activated, the electronic device may determine that the input device has been connected to the electronic device. If the input device is detachably installed input device or a physically independent input device, the input device may be connected wirelessly or by wire to the electronic device directly or via an intermediate electronic device.

Once the input device is connected to the electronic device, the electronic device may generate a pointer on a screen of a display in step 520. The electronic device may receive an input signal related to movement of the pointer from the input device and thus may move the pointer on the screen of the display according to the input signal.

The electronic device may determine whether or not the pointer is poisoned in a hard key mapping area mapped to at least one hard key on the screen of the display in step 530. If the pointer is positioned in the hard key mapping area mapped to the at least one hard key during movement, the procedure proceeds to step 540. If the pointer generated in step 520 is positioned in a hard key mapping area, the procedure also proceeds to step 540. Otherwise, the electronic device may wait until the pointer is positioned in a hard key mapping area mapped to at least one hard key during movement.

The electronic device may receive a selection signal related to execution of a function corresponding to a hard key from the input device. If the pointer is positioned in an area other than any hard key mapping area, the electronic device may not perform a function corresponding to a hard key despite receiving a selection signal from the input device.

Upon receiving a selection signal from the input device with the pointer in the hard key mapping area mapped to the at least one hard key on the display, the electronic device may execute a function corresponding to the at least one hard key according to the selection signal in step 540.

If a plurality of hard keys are mapped to the hard key mapping area in which the pointer is positioned, the electronic device may select one of user-desired functions corresponding to the hard keys according to an input signal received from the input device and execute the selected function according to a selection signal.

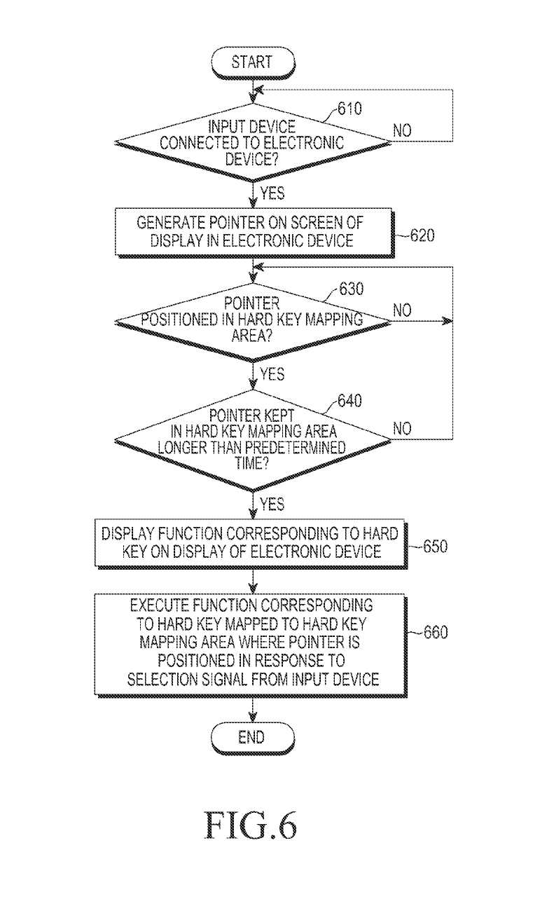

FIG. 6 is a flowchart illustrating a method for controlling an external input device according to an embodiment of the present invention.

Referring to FIG. 6, an electronic device may determine whether or not an input device has been connected to the electronic device in step 610. If the input device has been connected to the electronic device, the procedure proceeds to step 620. Otherwise, if the input device has not been connected to the electronic device, the electronic device may wait until it is connected to the input device.

Once the input device is connected to the electronic device, the electronic device may generate a pointer on a screen of a display in step 620. The electronic device may receive an input signal related to movement of the pointer from the input device and thus may move the pointer on the screen of the display according to the input signal.

The electronic device may determine whether or not the pointer is positioned in a hard key mapping area mapped to at least one hard key on the screen of the display in step 630. If the pointer is positioned in the hard key mapping area mapped to the at least one hard key during movement, the procedure proceeds to step 540. If the pointer generated in step 620 is positioned in a hard key mapping area, the procedure also proceeds to step 640. Otherwise, the electronic device may wait until the pointer is positioned in a hard key mapping area mapped to at least one hard key during movement.

Once the pointer is positioned in a hard key mapping area mapped to at least one hard key, the electronic device may count the time over which the pointer stays in the hard key mapping area. The electronic device may determine whether or not the pointer is kept in the hard key mapping area longer than a predetermined time in step 640. If the pointer is kept in the hard key mapping area longer than the predetermined time, the electronic device may proceed to step 650. On the other hand, if the pointer moves out of the hard key mapping area before the predetermined time expires, the electronic device may return to step 630.

If the pointer is kept in the hard key mapping area longer than the predetermined time, the electronic device may display one or more functions corresponding to the at least one hard key mapped to the hard key mapping area in step 660. The function may be any of a text, a figure, and an icon displayed on the screen of the display.

A selection signal generated from the input device is related to selection of a function corresponding to a hard key. The selection signal may be a single signal or a combination of signals. For example, if the input device is a mouse, when a pointer enters into a hard key mapping area mapped to at least one hard key on the display, the electronic device may receive one of the following: a mouse left-button signal, a mouse right-button signal, and a mouse wheel signal, and may execute a function corresponding to a hard key according to the received signal. In another example, the electronic device may receive at least two of following: a mouse left-button signal, a mouse right-button signal, and a mouse wheel signal, and may execute a function corresponding to a hard key according to the received signals. In another example, the selection signal from the input device may be a combination of signals generated from an input means of the input device. If the input device is an electronic pen having a single button, the electronic device may count the receptions of one button signal from the electronic pen for a predetermined time, recognize the count as a selection signal, and execute a function corresponding to a hard key according to the count.

The selection signal from the input device may include a hard key signal generated from the input device, a combination of hard key signals generated from the input device, or a soft key signal generated from the input device.

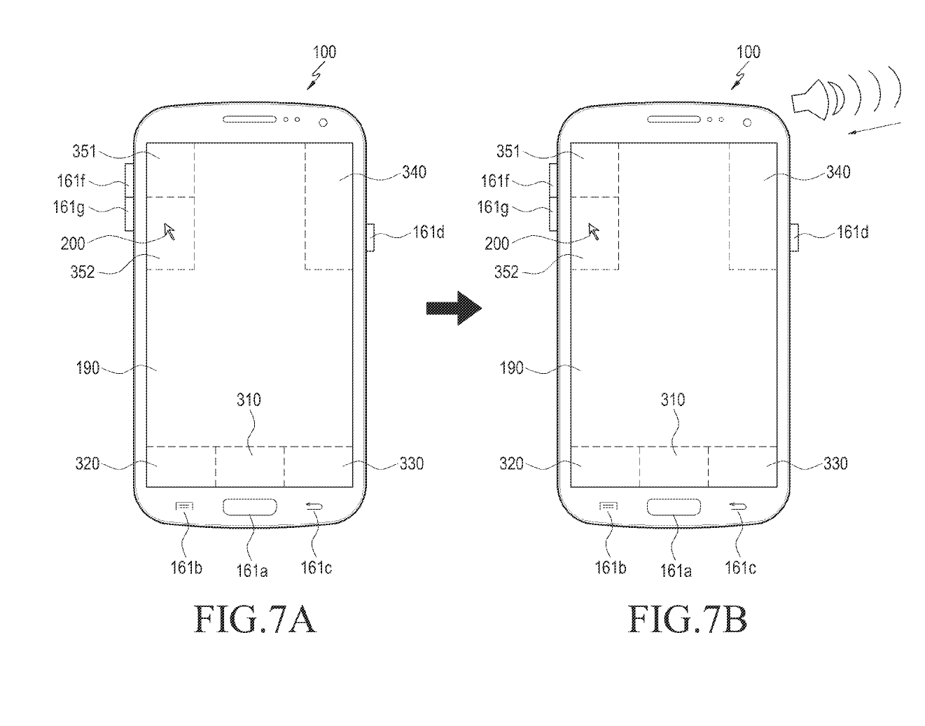

FIGS. 7A and 7B illustrate an application example of a method of controlling an external input device according to an embodiment of the present invention.

Referring to FIG. 7A, the portable terminal 100 is illustrated as an electronic device according to an embodiment of the present invention. The portable terminal 100 includes a plurality of hard keys. The volume-up button 161 f and the volume-down button 161g may be formed as hard keys on a left side surface of the housing of the portable terminal 100. The power/lock button 161 d that powers on or off the portable terminal 100 or locks the portable terminal 100 may be formed as a hard key on a right side surface of the housing of the portable terminal 100. The home button 161a that displays a main home screen on the touch screen 190, the menu button 161b that provides a link menu on the touch screen 190, and the back button 161 c that displays the previous screen or terminates the latest executed application may be formed as hard keys on the bottom of the touch screen 190 in the portable terminal 100.

Hard key mapping areas to which the hard keys are mapped are displayed on the touch screen 190 of the portable terminal 100. A hard key mapping area 351 mapped to the volume-up button 161f and a hard key mapping area 352 mapped to the volume-down button 161g may be defined at an upper left-hand corner of the touch screen 190. A hard key mapping area 340 mapped to the power/lock button 161d may be defined at an upper right-hand corner of the touch screen 190. A hard key mapping area 320 mapped to the menu button 161b may be defined at a lower left-hand corner of the touch screen 190. A hard key mapping area 310 mapped to the home button 161 a may be defined at a lower center of the touch screen 190. A hard key mapping area 330 mapped to the back button 161c may be defined at a lower right-hand corner of the touch screen 190.

Referring to FIG. 7B, while an input device is connected to the portable terminal 100, a pointer 200 is positioned in a hard key mapping area defined on the touch screen 190 of the portable terminal 100. The portable terminal 100 may receive an input signal corresponding to movement of the pointer 200 and move the pointer 200 according to the input signal on the touch screen 190. For example, the pointer 200 enters into the hard key mapping area 352 mapped to the volume-down button 161g during movement. The portable terminal 100 may determine whether or not the pointer 200 is positioned in a hard key mapping area mapped to at least one hard key on the touch screen 190. Thus, the portable terminal 100 may determine that the pointer 200 is positioned in the hard key mapping area 352 mapped to the volume-down button 161g. The portable terminal 100 may receive a selection signal that executes a function corresponding to the hard key and thus may turn down the sound volume of the portable terminal 100, as the executed function corresponding to the hard key mapped to the hard key mapping area in which the pointer 200 is currently positioned, according to the received selection signal.

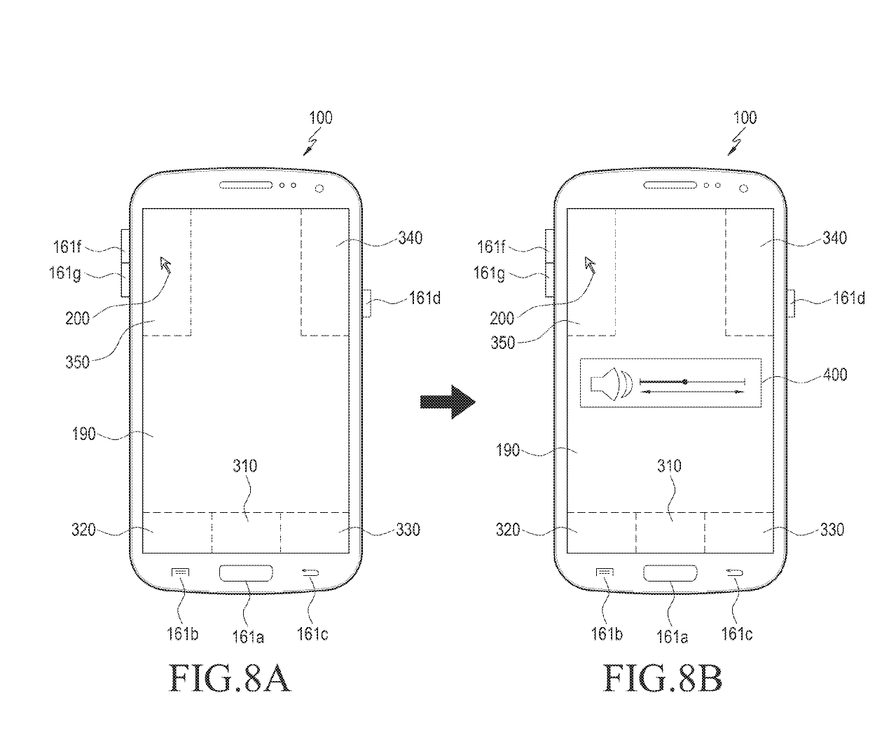

FIGS. 8A and 8B illustrate an application example of a method of controlling an external input device according to an embodiment of the present invention. As described with reference to FIGS. 7A and 7B, hard key mapping areas are mapped to hard keys in a one-to-one correspondence on a screen of a display in an electronic device according to an embodiment of the present invention. Now a hard key mapping area mapped to a plurality of hard keys will be described and displayed on a screen of a display in an electronic device according to an embodiment of the present invention, with reference to FIGS. 8A and 8B. The portable terminal 100 includes a plurality of hard keys. The same hard keys as illustrated in FIGS. 7A and 7B may be formed in FIGS. 8A and 8B, respectively. The hard keys of the portable terminal 100 have been described above with reference to FIGS. 7A and 7B and thus will not be described herein to avoid redundancy.

Hard key mapping areas mapped to the hard keys of the portable terminal 100 are displayed on the touch screen 190 in the portable terminal 100 in FIGS. 7A, 7B, 8A and 8B. While the hard key mapping area 351 mapped to the volume-up button 161f and the hard key mapping area 352 mapped to the volume-down button 161g are defined at the left upper-right hand corner of the touch screen 190 in FIGS. 7A and 7B, one common hard key mapping area 350 mapped to the volume-up button 161f and the volume-down button 161g is defined in FIGS. 8A and 8B. The other hard keys are mapped to the other hard key mapping areas in a one-to-one correspondence in the same manner as illustrated in FIGS. 7A and 7B and thus will not be described in detail herein.

Referring to FIG. 8B, the pointer 200 enters into the common hard key mapping area 350 mapped to the volume-up button 161f and the volume-down button 161g on the touch screen 190 in the portable terminal 100. The portable terminal 100 may display functions corresponding to the hard keys mapped to the hard key mapping area in which the pointer 200 is positioned. The functions may be any of a text, a figure, and an icon displayed on the touch screen 190. The portable terminal 100 may determine that the pointer 200 is positioned in the hard key mapping area 350 mapped commonly to the volume-up button 161 f and the volume-down button 161g. A volume control function is displayed in the form of a FIG. 400 on the touch screen 190. The portable terminal 100 may receive a selection signal from the input device. The selection signal is related to execution of a volume-up function or a volume-down function. The portable terminal 200 may turn up or turn down the sound volume of the portable terminal 100, as one of executed functions corresponding to the hard keys mapped to the hard key mapping area in which the pointer 200 is currently positioned, according to the received selection signal.

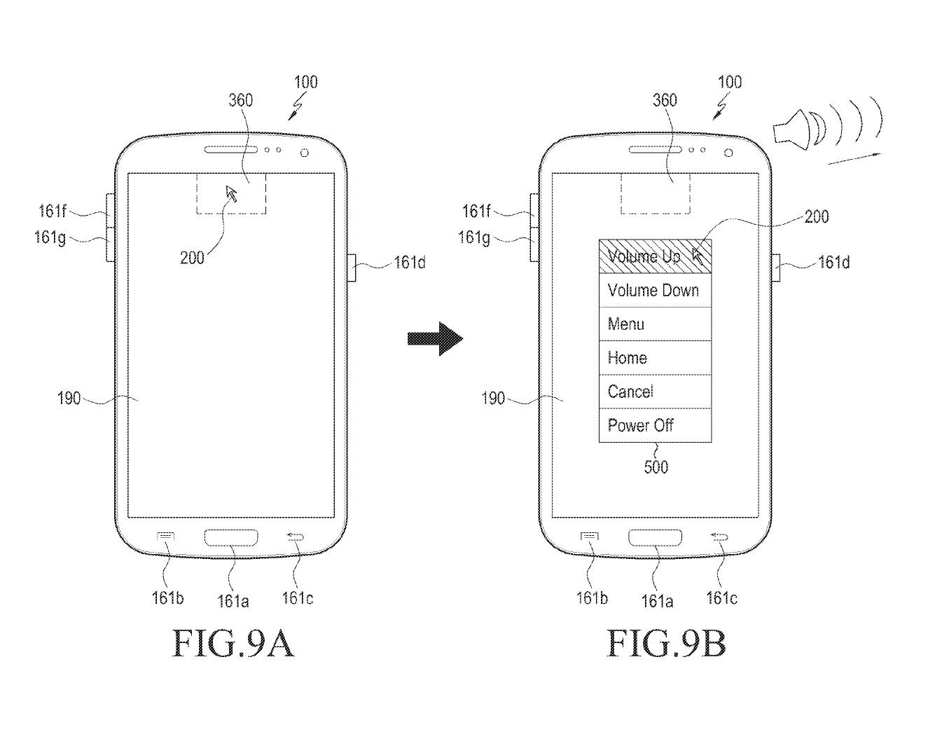

FIGS. 9A and 9B illustrate an application example of a method of controlling an external input device according to an embodiment of the present invention. In FIGS. 9A and 9B, the portable terminal 100 is illustrated as an example of the electronic device. The portable terminal 100 includes a plurality of hard keys. The same hard keys as illustrated in FIGS. 7A and 7B may be formed in FIGS. 9A and 9B, respectively. The hard keys of the portable terminal 100 have been described above with reference to FIGS. 7A and 7B and thus will not be described herein redundantly.

A hard key mapping area 360 mapped to the hard keys of the portable terminal 100 is displayed on the touch screen 190 in the portable terminal 100. While the hard key mapping area 360 is defined at an upper end of the touch screen 190 in FIGS. 9A and 9B, the present invention is not limited thereto. Thus, the hard key mapping area 360 may be defined in any area of the touch screen 190 in the portable terminal 100. The single hard key mapping area 360 may be mapped to a plurality of hard keys of the portable terminal 100.

Referring to FIG. 9B, the portable terminal 100 may determine whether or not the pointer 200 is positioned in the common hard key mapping area 360 mapped to the plurality of hard keys in the portable terminal 100. If the pointer 200 is positioned in the common hard key mapping area 360 mapped to the plurality of hard keys, functions corresponding to the hard keys may be displayed in a list 500 on the touch screen 190. Then, upon receiving a selection signal from the input device, the portable terminal 100 may perform one of functions corresponding to the hard keys mapped to the hard key mapping area in which the pointer 200 is currently positioned, according to the received selection signal.

Each function of the hard keys mapped to the hard key mapping area 360 in which the pointer 200 is positioned may be displayed sequentially in the form of any of a text, a figure, and an icon in a predetermined order according to an input signal received from the input device.

As is apparent from the above description of the present invention, a user can control hard keys of an electronic device through an input device connected to the electronic device.

Information about the method of controlling an external input device may be recorded in a computer-readable recording medium. The computer-readable recording medium is any type of a recording medium that stores a program and data readable by a computer system. Examples of the recording medium include a Read Only Memory (ROM), a Random Access Memory (RAM), a Compact Disk (CD), a Digital Versatile Disk-ROM (DVD-ROM), a magnetic tape, a floppy disk, an optical data storage, an embedded Multi Media Card (eMMC), and a carrier wave (e.g., data transmission over the Internet). The computer-readable recording medium may be distributed over a plurality of computer systems connected to a network so that computer-readable code is written thereto and executed therefrom in a decentralized manner.

Furthermore, the user can selectively control an intended hard key through the input device and confirm the selection of the hard key on a screen of a display in the electronic device.

In the present invention, a component may refer to a functional, structural combination of hardware that implements the technical features of the present invention and software that operates the hardware. For example, each functional block may be a logical unit of a specific code and hardware resources needed to implement the specific code. Those skilled in the art will readily understand that each function block is not necessarily a physically connected code or one type of hardware.

At this point it should be noted that the embodiments of the present invention as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the embodiments of the present invention as described above. Alternatively, one or more processors operating in accordance with stored instructions may be implemented the functions associated with the embodiments of the present invention as described above. If such is the case, it is within the scope of the present invention that such instructions may be stored on one or more processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. Moreover, functional computer programs, instructions, and instruction segments for accomplishing the present invention can be easily construed by programmers skilled in the art to which the present invention pertains.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method of controlling an electronic device connected to an external input device that provides a user input, the method comprising:
displaying a pointer controlled according to a signal generated from the external input device; and
displaying a menu corresponding to a key button of the electronic device, upon receiving one of a specific signal from the external input device and if the pointer is positioned in a specific area.

2. The method of claim 1, wherein the specific area is defined in a part of a display, near to the key button of the electronic device.

3. The method of claim 1, wherein the specific signal is at least one key button input signal received from the external input device.

4. The method of claim 1, wherein a function on the menu corresponding to the key button is identical to a function corresponding to the key button.

5. The method of claim 1, further comprising:
executing a function of the key button corresponding to the selected menu, upon selecting the menu by the external input device.

6. The method of claim 1, further comprising:
determining whether the pointer is kept in the specific area longer than a predetermined time, before displaying the menu.

7. The method of claim 1, wherein displaying the menu comprises displaying the menu as at least one of a text, a figure, an icon, and a function list.

8. The method of claim 1, wherein displaying the menu comprises, if a plurality of menus correspond to the key button, displaying the plurality of menus on a display of the electronic device.

9. The method of claim 1, wherein displaying the menu comprises, if a plurality of menus correspond to the key button, displaying the plurality of menus one by one on a display of the electronic device by the input device.

10. A computer-readable recording medium having recorded thereon a program to perform a method of controlling an electronic device connected to an external input device that provides a user input, the method comprising:
displaying a pointer controlled according to a signal generated from the external input device; and
displaying a menu corresponding to a key button of the electronic device, upon receiving one of a specific signal from the external input device and if the pointer is positioned in a specific area.

11. An electronic device connected to an external input device, the electronic device comprising:
a communication unit configured to receive a signal generated from the external input device; and
a controller configured to control display of a pointer according to the signal and to control display of a menu corresponding to a key button of the electronic device, upon receiving one of a specific signal from the external input device and if the pointer is positioned in a specific area.

12. The electronic device of claim 11, wherein the specific area is defined in a part of a display, near to the key button of the electronic device.

13. The electronic device of claim 11, wherein the specific signal is at least one key button input signal received from the external input device.

14. The electronic device of claim 11, wherein a function on the menu corresponding to the key button is identical to a function corresponding to the key button.

15. The electronic device of claim 11, wherein upon selecting the menu by the external input device, the controller controls execution of a function of the key button corresponding to the selected menu.

16. The electronic device of claim 11, wherein the controller determines whether the pointer is kept in the specific area longer than a predetermined time, before the menu is displayed.

17. The electronic device of claim 11, wherein the controller controls display of the menu as at least one of a text, a figure, an icon, and a function list.

18. The electronic device of claim 11, wherein if a plurality of menus correspond to the key button, the controller controls display of the plurality of menus on a display of the electronic device.

19. The electronic device of claim 11, wherein if a plurality of menus correspond to the key button, the controller controls display of the plurality of menus one by one on a display of the electronic device by the input device.
